(19) United States
(12) Patent Application Publication
(10) Pub. No.: US 2026/0027475 A1
(43) Pub. Date: Jan. 29, 2026

(54) ELECTRONIC GAME CUSTOMIZATION

(71) Applicant: IGT, Las Vegas, NV (US)

(72) Inventors: Soheil Latifi, Brampton (CA); Stefan Keilwert, St. Josef (AT); Michael Russ, Graz (AT); Sven Aurich, Schwanberg (AT)

(21) Appl. No.: 18/785,741

(22) Filed: Jul. 26, 2024

(51) Int. Cl. A63F 13/67

(52) U.S. Cl. CPC A63F 13/67

(57) ABSTRACT

Embodiments of the present disclosure are directed to customizing an electronic game. Generally speaking, one or more trained models of electronic game characteristics can be applied by a host system using Artificial Intelligence (AI) to generate customizations for one or more characteristics of an electronic game. The generated characteristics can be further based on and/or in response to tracking game play information of a particular player for which they are generated. For example, if the player has slowed or otherwise changed play of the game indicating a possible loss of interest in the game, new characteristics can be generated and applied to the game to renew interest by the player. In other cases, the new characteristics can be generated and applied in response to a request from the player.

### BACKGROUND

The present disclosure is generally directed to electronic gaming and more particularly to customizing an electronic game.

Studies have shown that electronic games, such as those executed on a Electronic Gaming Machine (EGM) in a casino, become boring for veteran players, often resulting in them abstaining from playing. Thus, if the players reach a point where they think they have seen it all, they stop playing the game. For example, paytables for the game can become annoying and repetitive after a while. Business response to this has been deploying paytable patches and updates to keep the games fun and playable or simply making new games to replace the older ones. However, this is time consuming, costly, may not appeal to the players, and is still prone to loss of interest after some time.

### BRIEF SUMMARY

Embodiments of the present disclosure are directed to customizing an electronic game based on player activity. According to one embodiment, a method for customizing an electronic game can comprise training a model representing a plurality of characteristics of electronic games. For example, training the model representing the plurality of characteristics of electronic games can comprise training the model on a plurality of different electronic games.

A player of the electronic game can be identified. Activity of the player while playing the electronic game can then be tracked. Tracking the activity of the player while playing the electronic game can comprise tracking the activity of the player across a plurality of session of the electronic game.

A characteristic for the electronic game can be generated based on the model representing the plurality of characteristics of the electronic game and the activity of the player while playing the electronic game. For example, generating the characteristic for the electronic game can comprise generating a paytable for the electronic game. In such cases, generating the paytable for the electronic game can be further based on a set of constraints for limiting an overall payout for the electronic game.

The electronic game can then be undated with the generated characteristic. In some cases, generating the characteristic for the electronic game and updating the electronic game with the generated characteristic can be performed automatically based on tracking the activity of the player while playing the electronic game. Additionally, or alternatively, generating the characteristic for the electronic game and updating the electronic game with the generated characteristic can be performed in response to a request from the player.

According to another embodiment, a system can comprise a processor and a memory coupled with and readable by the processor. The memory can store therein a set of instructions which, when executed by the processor, causes the processor to maintain a model representing a plurality of characteristics of electronic games. Maintaining the model representing the plurality of characteristics of electronic games can comprise training the model the model on a plurality of different electronic games.

The instructions can further cause the processor to identify a player of the electronic game and track activity of the player while playing the electronic game. Tracking the activity of the player can comprise tracking the activity of the player across a plurality of sessions of the electronic game. Additionally, or alternatively, tracking the activity of the player can comprise tracking the activity of the player across a plurality of electronic games.

The instructions can further cause the processor to generate a plurality of characteristics for the electronic game based on the model representing the plurality of characteristics of the electronic game and the activity of the player while playing the electronic game and update the electronic game with the generated plurality of characteristics. In some cases, tracking the activity of the player can further comprise determining an objective of the player based on the activity of the player while playing the electronic game and generating the characteristic for the electronic game is further based on the determined objective of the player. Additionally, or alternatively, tracking the activity of the player can further comprise determining a player type for the player based on the activity of the player while playing the electronic game and wherein generating the characteristic for the electronic game is further based on the determined player type for the player. Generating the plurality of characteristics for the electronic game can comprise, for example, generating a paytable for the electronic game and generating the paytable for the electronic game can be further based on a set of constraints for limiting an overall payout for the electronic game.

According to yet another embodiment, a system can comprise a communications network and a gaming system coupled with the communications network. The gaming system can comprise a processor and a memory coupled with and readable by the processor of the gaming system. The memory can store therein a set of instructions which, when executed by the processor of the gaming system, can cause the processor of the gaming system to execute and electronic game and send game play information over the communications network.

The system can further comprise a host system coupled with the communications network. The host system can comprise a processor and a memory coupled with and readable by the processor of the host system. The memory can store therein a set of instructions which, when executed by the processor of the host system, causes the processor of the host system to receive the game play information from the gaming system, identify a player of the electronic game, track activity of the player while playing the electronic game based on the received game play information, generate a plurality of characteristics for the electronic game based on a model representing the plurality of characteristics of the electronic game and the activity of the player while playing the electronic game, and provide the generated plurality of characteristics to the gaming system through the communications network. For example, generating the plurality of characteristics for the electronic game can comprise generating a paytable for the electronic game and generating the paytable for the electronic game can be further based on a set of constraints for limiting an overall payout for the electronic game.

The instructions stored in the memory of the gaming system can further causes the processor of the gaming system to receive the generated plurality of characteristics from the host system and apply the generated plurality of characteristics to the electronic game. In some cases, the instructions stored in the memory of the gaming system further causes the processor of the gaming system to receive the generated plurality of characteristics from the host system and present the generated plurality of characteristics to the player. For example, the generated plurality of characteristics can be presented to the player with an option to accept or reject the generated plurality of characteristics and the instructions stored in the memory of the gaming system can further causes the processor of the gaming system to receive an input indicating acceptance of the generated plurality of characteristics and apply the generated plurality of characteristics to the electronic game in response to the received input. In another example, the generated plurality of characteristics can be presented to the player as individual options and the instructions stored in the memory of the gaming system further causes the processor of the gaming system to receive an input indicating acceptance of a selected characteristic of the generated plurality of characteristics and apply the selected characteristic to the electronic game in response to the received input.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment in which embodiments of the present disclosure can be implemented.

FIG. 2 is a block diagram illustrating additional details of components of an exemplary gaming host system according to one embodiment of the present disclosure.

FIG. 3 is a block diagram illustrating additional details of components of an exemplary gaming system according to one embodiment of the present disclosure.

FIG. 4 is a flowchart illustrating an exemplary process for customizing an electronic game according to one embodiment of the present disclosure.

FIG. 5 is a flowchart illustrating an exemplary process for customizing an electronic game according to another embodiment of the present disclosure.

### DETAILED DESCRIPTION

Embodiments of the present disclosure are directed to customizing an electronic game. Generally speaking, one or more trained models of electronic game characteristics can be applied by a host system using Artificial Intelligence (AI) to generate customizations for one or more characteristics of an electronic game. The generated characteristics can be further based on and/or in response to tracking game play information of a particular player for which they are generated. For example, if the player has slowed or otherwise changed play of the game indicating a possible loss of interest in the game, new characteristics can be generated and applied to the game to renew interest by the player. In other cases, the new characteristics can be generated and applied in response to a request from the player.

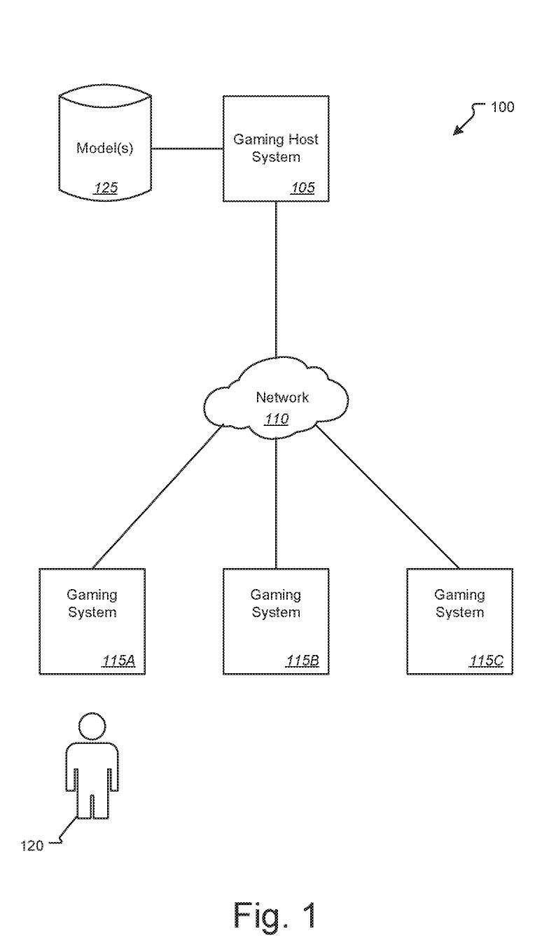

FIG. 1 is a block diagram illustrating an exemplary environment in which embodiments of the present disclosure can be implemented. As illustrated in this example, the environment 100 can comprise a gaming host system 105 coupled with a communications network 110. Generally speaking, the game host system 105 can comprise any one or more servers and/or other computing devices as known in the art and which may be used, for example, by an electronic game design studio. The communications network 110 can comprise any one or more wired and/or wireless, local-area and/or wide-area networks as known in the art including, but not limited to, the Internet.

Also coupled with the communications network 110 can be any number of gaming systems 115A-115C. Generally speaking, each gaming system 115A-115C can comprise, for example, any Electronic Gaming Machine (EGM), kiosk, or similar gaming system as may be found in a casino or other gaming venue. The gaming systems 115A-115C can each execute any of a variety of electronic games including, but not limited to slots, video slots, video poker, keno, etc. to be played by players 120A-120C.

As introduced above, the gaming host system 105 can monitor game play on the gaming systems 115A-115C and customize an electronic game played thereon. Accordingly, the gaming host system 105 can train and maintain one or more models 125 of electronic game characteristics. These model(s) 125 can be trained on characteristics, such as paytables, of various games using a neural network. The host system 105 can apply a generative AI using these models 125 to generate customizations for one or more characteristics of an electronic game. The generated characteristics can be further based on and/or in response to tracking game play information of a particular player 120 for which they are generated. For example, if the player 120 has slowed or otherwise changed play of the game indicating a possible loss of interest in the game, new characteristics can be generated and applied to the game to renew interest by the player. In other cases, the new characteristics can be generated and applied in response to a request from the player.

Once generated, the new characteristics can be provided to the gaming system 115A the player 120 is using. The gaming system 115A can then update the electronic game with the provided new characteristics. In some cases, this update can be applied automatically. In other cases, updates may be presented by the gaming system 115a to the player, e.g., through the gaming system’s display. In such cases, the player may be given an option to accept the new characteristics, select certain ones of the new characteristics, etc. before they are applied.

For example, the player can be presented a shortened list of potentially attractive game and/o math characteristics, e.g., top symbol win amount, scatter times two win amount, five-in-a-row win amount, etc., that, upon pressing the shuffle button, can be randomized and the new outcome presented. The player can then decide to play using these new characteristics or return to previous ones. Shuffle button activation may be granted through in-game rewards, game progress etc. In other implementations, players may be prompted to pay for a shuffle. According to one embodiment, the list of presented, available game and/or math characteristics to shuffle may differ from game to game.

Additionally, or alternatively, the player might be offered the option to shuffle three or some other number of times. After each shuffle the player might hold one of the offered game characteristics and re-shuffle to improve the outcome of the remaining characteristics.

According to one embodiment, the player may be presented an option to select characteristics to be shuffled. For example, the player can be presented a list of game characteristics and prompted to pick five of them. Each game characteristic can have its own probability to turn into a more attractive value. The probabilities can be communicated to the player, e.g., visually through the gaming system 115A, as risky versus conservative options. Once the player makes a selection and continues pressing the shuffle button, the selected items can be randomized. Shuffle-able game characteristics can include, but are not limited to, win amounts of symbol combinations, win amounts or min-max win ranges of bonus games, probabilities of game events, e.g., bonus trigger, jackpot-trigger, etc., money on reel values or distribution range of values, conditions to trigger a game event, e.g., four symbols only to trigger a bonus instead of five, and/or others.

According to one embodiment, the host system 105 or gaming system 115A can track which features, bonuses, and/or game events the player has experienced already. Once everything is experienced, generation of new features or characteristics can be triggered automatically. The host system 105 or gaming system 115A can track experienced events based on player tracking, such as a tracking card or a mobile progress tracking app, even beyond multiple play sessions or casino visits with persistence tracking. In some cases, the host system 105 or gaming system 115A can track experienced events anonymously for the current play session.

According to one embodiment, the player could let the gaming system or host system know what they are trying to achieve. This could be different from game to game, so they can state this on a game-by-game basis. Once all stated objectives are achieved, such as “I want to play all bonuses,” customization of the game can be triggered automatically. According to one embodiment, instead of the player manually defining goals, AI algorithms can be used for player tracking over time, identifying the player’s exit scenarios from the past, e.g., “It looks like the player stops playing a game once all bonuses are played.” In this embodiment, an AI model can be trained with exit scenarios of the player’s past game play and predict a player’s exit point, before it happens, to trigger player-relevant customizations to extend their gameplay. Based on that tracking, the gaming system of host system could automatically trigger a customization without letting the player know. This could be such as introducing another bonus to the game, so that the player is motivated to keep playing for longer, to achieve the added bonus as well.

Based on historical gameplay, each player’s appealing customizations can be tracked and based thereon, the player can be categorized, e.g., an “achieve all bonuses”-like player. This identified categorization data can be used for gaining a better understanding about player behaviors and player needs, e.g., via clustering. In addition to tracking and categorizing the player, the host system can implement measures to verify whether the assumed appealing customizations are really appealing to the player. For example, the host system can track whether a customization through adding another bonus to a bonus-hunter appealed player has really led to an extended time on the gaming system compared to a session where customization has not been triggered.

According to one embodiment, various announcements and/or other information about potential customizations can be provided. For example, an announcement of seasonal bonuses can be provided depending on the date, e.g., a spring feature, summer-smash, winter-party, etc. An announcement of marketing bonuses can be provided, e.g., “You will get 10% more win in this feature next week.” In some cases, announcement of customizations can be made through a mobile app or by sending messages messages that the game has new features. IN some cases, this can include sending screenshots of the new features to the player’s mobile device.

According to one embodiment, presentation of bonuses can be adjusted to the current game progress. For example, depending on whether the player is on a winning or losing path, the presentation of the win can be changed. For example, the history of this bonus can be presented. In another example, how much the player has achieved the last time in this bonus or how much “new” there is still to discover can be presented.

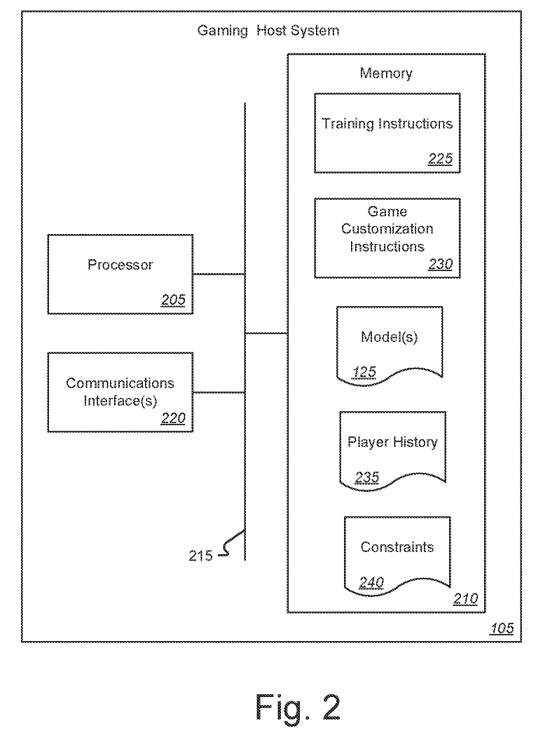

FIG. 2 is a block diagram illustrating additional details of components of an exemplary gaming host system according to one embodiment of the present disclosure. As illustrated in this example, a gaming host system 105 such as described above can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the gaming host system 105 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interface(s) 220 via the communications bus 215. The communication interface(s) 220 can comprise, for example, an Ethernet, Bluetooth, WiFi, cellular, and/or other type of wired and/or wireless communications interface. Via the communication interface(s) 220, the gaming host system 105 can communicate with other devices and/or systems through a communications network 115 as described above.

The memory 210 can store therein a set of training instructions 225 which, when executed by the processor 205, cause the processor 205 to train a model 125 representing a plurality of characteristics of electronic games. Training the model 125 representing the plurality of characteristics of electronic games can comprise training the model 125 on a plurality of different electronic games based on game play and/or other information collected from the various games.

The memory 210 can store therein a set of game customization instructions 225 which, when executed by the processor 205, cause the processor 205 to identify a player 120 of the electronic game, e.g., based on a player identifier received from a gaming system 115A via the communications interface 220 when the player 120 initiates game play thereon. The game customization instructions 225 can then cause the processor 205 to track activity of the player 120 and maintain a player history 235 while playing the electronic game. Tracking the activity of the player while playing the electronic game can comprise tracking the activity of the player across a plurality of session of the electronic game across a plurality of sessions of the electronic game and/or across a plurality of electronic games. According to one embodiment, tracking the activity of the player 120 can further comprise determining an objective of the player based on the activity of the player while playing the electronic game and/or determining a player type for the player based on the activity of the player while playing the electronic game.

The game customization instructions 225 can further cause the processor 205 to generate one or more characteristics for the electronic game based on the model 125 representing the plurality of characteristics of the electronic game and the activity of the player 120 while playing the electronic game. For example, generating the characteristic for the electronic game can comprise generating a paytable for the electronic game. In such a cases, generating the paytable for the electronic game can be further based on a set of constraints 240 for limiting an overall payout for the electronic game. Generating the characteristic for the electronic game can be further based on the determined objective of the player and/or the determined player type for the player, if any.

The game customization instructions 225 can then cause the processor 205 to update the electronic game with the generated characteristic, e.g., by providing the generated characteristics to the gaming system 120 via the communications interface 220. According to one embodiment, generating the characteristic for the electronic game and updating the electronic game with the generated characteristic can be performed automatically, based on tracking the activity of the player while playing the electronic game, e.g., based on changed or decreased play possibly indicating the player is losing interest in the game. Additionally, or alternatively, generating the characteristic for the electronic game and updating the electronic game with the generated characteristic is performed in response to a request from the player.

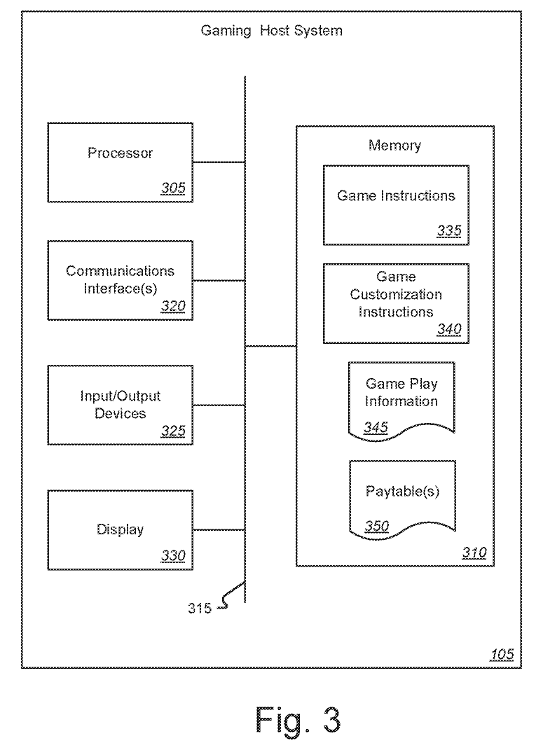

FIG. 3 is a block diagram illustrating additional details of components of an exemplary gaming system according to one embodiment of the present disclosure. As illustrated in this example, a responsible gaming system 125 can comprise a processor 305 such as any of the various types of processors described above. A memory 310 can be coupled with and readable by the processor 305 via a communications bus 315. The memory 310 can comprise any one or more of the different types of volatile and/or non-volatile memories described above. The processor 305 can also be coupled with one or more communication interfaces 320, one or more input/output devices 325, and a display 330. The communication interfaces 320 can comprise, for example, an Ethernet, Bluetooth, WiFi, cellular, and/or other type of wired and/or wireless communications interface. The input/output devices 225 can include, but are not limited to, buttons, speakers, a ticket printer, one or more cameras, microphones, etc. The display can comprise a Liquid Crystal Display (LCD), Light Emitting Diode (LED), Organic Light Emitting Diode (OLED), or other type of display.

The memory 310 can store therein a set of game instructions 335 which, when executed by the processor 305, cause the processor 305 to execute an electronic game. The memory can also store therein a set of game customization instructions 340 which, when executed by the processor 305, can cause the processor 305 to send game play information 345 to a host system 105 through the communications interface(s) 320.

The game customization instructions 340 can then cause the processor 305 to receive, through the communications interface(s) 320, generated one or more characteristics from the host system 105. Optionally, the game customization instructions 340 can cause the processor 305 to present the generated characteristics to the player 120 through the display 330. In such cases, the generated characteristics can be presented to the player 120 with an option to accept or reject the generated characteristics, either in whole or individually.

The game customization instructions 340 can cause the processor 305 to receive, e.g., through input/output devices 325, an input indicating acceptance or rejection of the generated characteristics and make a determination as to whether to apply the generated characteristics can be made based on the input. In response to the received input, the game customization instructions 340 can then cause the processor 305 to apply the generated and accepted characteristics to the electronic game. In other cases, the game customization instructions 340 can cause the processor 305 to apply the generated characteristics automatically, without first being presented to the player for acceptance.

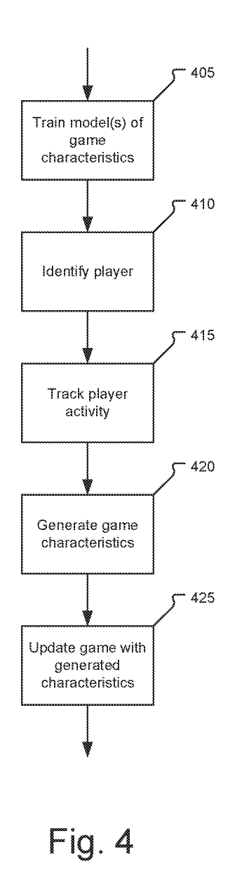

FIG. 4 is a flowchart illustrating an exemplary process for customizing an electronic game according to one embodiment of the present disclosure. As illustrated in this example, customizing an electronic game can comprise training 405 a model 125 representing a plurality of characteristics of electronic games. Training 405 the model 125 representing the plurality of characteristics of electronic games can comprise training the model 125 on a plurality of different electronic games based on game play and/or other information collected from the various games.

A player 120 of the electronic game can be identified 410, e.g., based on a player identifier received from a gaming system 115A when the player 120 initiates game play thereon. Activity of the player 120 can then be tracked 415 while playing the electronic game. Tracking 415 the activity of the player while playing the electronic game comprises tracking the activity of the player across a plurality of session of the electronic game across a plurality of sessions of the electronic game and/or across a plurality of electronic games. According to one embodiment, tracking 415 the activity of the player 120 can further comprise determining an objective of the player based on the activity of the player while playing the electronic game and/or determining a player type for the player based on the activity of the player while playing the electronic game.

One or more characteristics for the electronic game can be generated 420 based on the model 125 representing the plurality of characteristics of the electronic game and the activity of the player 120 while playing the electronic game. For example, generating 420 the characteristic for the electronic game can comprise generating a paytable 350 for the electronic game. In such a cases, generating the paytable 350 for the electronic game can be further based on a set of constraints 240 for limiting an overall payout for the electronic game. Generating 420 the characteristic for the electronic game can be further based on the determined objective of the player and/or the determined player type for the player, if any.

The electronic game can then be updated 425 with the generated characteristic. According to one embodiment, generating 420 the characteristic for the electronic game and updating 425 the electronic game with the generated characteristic can be performed automatically, based on tracking 415 the activity of the player while playing the electronic game, e.g., based on changed or decreased play possibly indicating the player is losing interest in the game. Additionally, or alternatively, generating 420 the characteristic for the electronic game and updating the 425 electronic game with the generated characteristic is performed in response to a request from the player.

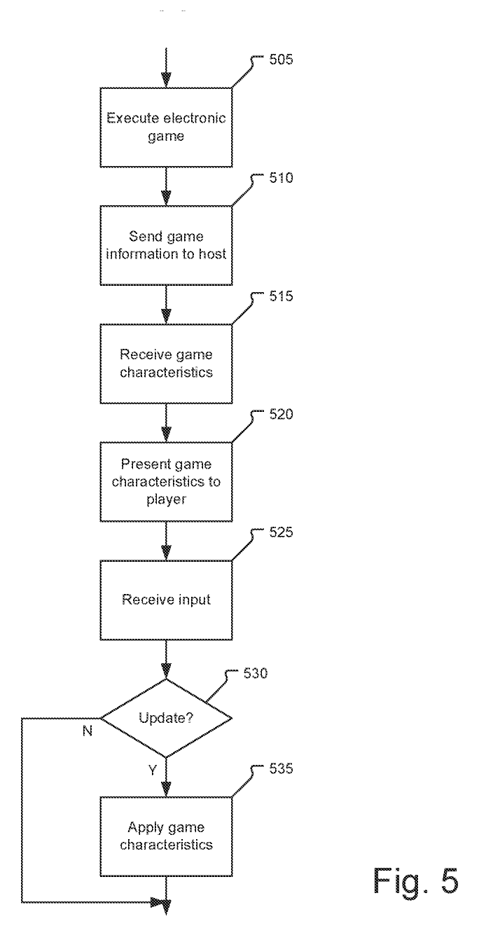

FIG. 5 is a flowchart illustrating an exemplary process for customizing an electronic game according to another embodiment of the present disclosure. As illustrated in this example, customizing the electronic game can comprise executing 505 an electronic game and sending 510 game play information over the communications network 110 to a host system 105.

A generated one or more characteristics can be received 515 from the host system 105. Optionally, the generated characteristics can be presented 520 to the player 120. In such cases, the generated characteristics can be presented to the player 120 with an option to accept or reject the generated characteristics, either in whole or individually.

An input indicating acceptance or rejection of the generated characteristics received 525 and a determination 530 as to whether to apply the generated characteristics can be made based on the input. In response to the received input, the generated and accepted characteristics can be applied 535 to the electronic game. In other cases, the generated characteristics can be applied 535 automatically, without first being presented 520 to the player for acceptance.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Patent No. 8,764,566, entitled “Internet Remote Game Server,” and U.S. Patent No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the "C" programming language, Visual Basic, Fortran 2003, Perl, COBOL 2002, PHP, ABAP, dynamic programming languages such as Python, Ruby and Groovy, or other programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for customizing an electronic game, the method comprising:
training, by a processor of a host system, a model representing a plurality of characteristics of electronic games;
identifying, by the processor of the host system, a player of the electronic game;
tracking, by the processor of the host system, activity of the player while playing the electronic game;
generating, by the processor of the host system, a characteristic for the electronic game based on the model representing the plurality of characteristics of the electronic game and the activity of the player while playing the electronic game; and
updating, by the processor of the host system, the electronic game with the generated characteristic.

2. The method of claim 1, wherein training the model representing the plurality of characteristics of electronic games comprises training the model on a plurality of different electronic games.

3. The method of claim 1, wherein generating the characteristic for the electronic game and updating the electronic game with the generated characteristic is performed automatically based on tracking the activity of the player while playing the electronic game.

4. The method of claim 1, wherein generating the characteristic for the electronic game and updating the electronic game with the generated characteristic is performed in response to a request from the player.

5. The method of claim 1, wherein tracking the activity of the player while playing the electronic game comprises tracking the activity of the player across a plurality of session of the electronic game.

6. The method of claim 1, wherein generating the characteristic for the electronic game comprises generating a paytable for the electronic game.

7. The method of claim 6, wherein generating the paytable for the electronic game is further based on a set of constraints for limiting an overall payout for the electronic game.

8. A system comprising:
a processor; and
a memory coupled with and readable by the processor and storing therein a set of instructions which, when executed by the processor, causes the processor to:
maintain a model representing a plurality of characteristics of electronic games;
identify a player of the electronic game;
track activity of the player while playing the electronic game;
generate a plurality of characteristics for the electronic game based on the model representing the plurality of characteristics of the electronic game and the activity of the player while playing the electronic game; and
update the electronic game with the generated plurality of characteristics.

9. The system of claim 8, wherein maintaining the model representing the plurality of characteristics of electronic games comprises training the model the model on a plurality of different electronic games.

10. The system of claim 8, wherein tracking the activity of the player further comprises determining an objective of the player based on the activity of the player while playing the electronic game and wherein generating the characteristic for the electronic game is further based on the determined objective of the player.

11. The system of claim 8, wherein tracking the activity of the player comprises tracking the activity of the player across a plurality of sessions of the electronic game.

12. The system of claim 8, wherein tracking the activity of the player comprises tracking the activity of the player across a plurality of electronic games.

13. The system of claim 8, wherein tracking the activity of the player further comprises determining a player type for the player based on the activity of the player while playing the electronic game and wherein generating the characteristic for the electronic game is further based on the determined player type for the player.

14. The system of claim 8, wherein generating the plurality of characteristics for the electronic game comprises generating a paytable for the electronic game and wherein generating the paytable for the electronic game is further based on a set of constraints for limiting an overall payout for the electronic game.

15. A system comprising:
a communications network;
a gaming system coupled with the communications network, the gaming system comprising a processor and a memory coupled with and readable by the processor of the gaming system and storing therein a set of instructions which, when executed by the processor of the gaming system, causes the processor of the gaming system to:
execute and electronic game; and
send game play information over the communications network; and
a host system coupled with the communications network, the host system comprising a processor and a memory coupled with and readable by the processor of the host system and storing therein a set of instructions which, when executed by the processor of the host system, causes the processor of the host system to:
receive the game play information from the gaming system;
identify a player of the electronic game;
track activity of the player while playing the electronic game based on the received game play information;
generate a plurality of characteristics for the electronic game based on a model representing the plurality of characteristics of the electronic game and the activity of the player while playing the electronic game; and
provide the generated plurality of characteristics to the gaming system through the communications network.

16. The system of claim 15, wherein the instructions stored in the memory of the gaming system further causes the processor of the gaming system to:
receive the generated plurality of characteristics from the host system; and
apply the generated plurality of characteristics to the electronic game.

17. The system of claim 15, wherein the instructions stored in the memory of the gaming system further causes the processor of the gaming system to:
receive the generated plurality of characteristics from the host system; and
present the generated plurality of characteristics to the player.

18. The system of claim 17, wherein the generated plurality of characteristics are presented to the player with an option to accept or reject the generated plurality of characteristics and wherein the instructions stored in the memory of the gaming system further causes the processor of the gaming system to:
receive an input indicating acceptance of the generated plurality of characteristics; and
apply the generated plurality of characteristics to the electronic game in response to the received input.

19. The system of claim 17, wherein the generated plurality of characteristics are presented to the player as individual options and wherein the instructions stored in the memory of the gaming system further causes the processor of the gaming system to:
receive an input indicating acceptance of a selected characteristic of the generated plurality of characteristics; and
apply the selected characteristic to the electronic game in response to the received input.

20. The system of claim 15, wherein generating the plurality of characteristics for the electronic game comprises generating a paytable for the electronic game and wherein generating the paytable for the electronic game is further based on a set of constraints for limiting an overall payout for the electronic game.
